(19) United States
(12) Patent Application Publication
(10) Pub. No.: US 2005/0253669 A1
(43) Pub. Date: Nov. 17, 2005

(54) Variably tuning antennas

(76) Inventor: James K. Tillery, Woodstock, GA (US)

Correspondence Address: REED SMITH LLP, 2500 One Liberty Place, 1650 Market Street, Philadelphia, PA, 19103-7301, US

(21) Appl. No.: 11/120,149

(22) Filed: May 2, 2005

Related U.S. Application Data
(60) Provisional application No. 60/566,705, filed on Apr. 30, 2004.

(51) Int. Cl. H01P 1/18

(52) U.S. Cl. 333/161; 333/33

(57) ABSTRACT

A tuneable antenna system and method is disclosed. The system includes a transmission line coupled to an antenna, the transmission line having a movable portion, wherein a first position of the movable portion provides to the transmission line a first path length different from a second path length at a second position of the movable portion and at least first and second tuner, wherein a coupling of the first tuner to the movable portion at the first position presents to the transmission line a first impedance, and wherein a coupling of the second tuner to the movable portion at the second position presents to the transmission line a second impedance different from the first impedance.

### CROSS-REFERENCE TO RELATED APPLICATIONS

This application is related to U.S. patent application Ser. No. 60/566,705, entitled “Method and Apparatus for Variably Tuning Variable Electrical Downtilt Antennas” and having named inventor Jim Tillery, which application is hereby incorporated by reference herein as if set forth in the entirety.

### FIELD OF THE INVENTION

This invention relates generally to antennae, and, more particularly, to variably tuning antennae, systems and methods.

### BACKGROUND OF THE INVENTION

Certain types of antennas, such as traditional cellular base station antennas, radiate energy in a fixed direction. The feed network within such an antenna excites each antenna element with the proper phase and magnitude in order to create a shaped antenna pattern that points at fixed azimuth and elevation angles. The direction, phase, and magnitude of such an antenna are examples of the antenna parameters that may be varied in accordance with the necessities of environmental or design modifications. For example, once such an antenna is installed, the direction of radiation of the antenna may be changed by either physically adjusting the position of the antenna, or replacing the antenna with another antenna with a different radiation pattern.

Due to the high costs associated with adjusting or replacing antennas, certain antennas have been developed for which radiation patterns, phase, and/or magnitude may be modified from a local or remote location. The first generation of these variable antennas employs Variable Electrical Downtilt (VED), which subjects the antenna field to a varied elevation pointing angle. Such antennas impose unique design challenges due to the complexity of the feed networks. One of these design challenges is impedance matching.

In an ideal antenna, all of the incident electric field, i.e., the energy that is input into the antenna, is transmitted from the antenna. In this case, the load impedance is equal to the characteristic impedance of the transmission line, and there are no reflections in the feed network. In reality, of course, some of the incident electric field is reflected back towards the source due to impedance mismatches. Impedance mismatches may be caused by connector interfaces, poorly matched components, solder junctions, equipment variations, and the like. Along the transmission line, the reflected electric field may combine with the incident electric field to set up standing waves in the feed network. The same phenomenon occurs to the magnetic fields on the transmission line, although their standing wave pattern is different than that of the electric field. Since the impedance of the transmission line is determined by the ratio of the electric and magnetic fields, and the electric and magnetic fields vary differently along the transmission line, the impedance along the line will vary as well. This variance in impedance may have a deleterious effect on signal quality and/or gain for the subject antenna embodiment. As such, reflections are undesirable and should be reduced or eliminated.

In an exemplary variable antenna embodiment in which deleterious impedance mismatches may occur, the phase of an antenna may be varied through the movement of one or more elements associated with the antenna or the transmission line from a first position to a second position, and this equipment variation may cause the impedance mismatches in the manner discussed above. A common method used to reduce reflections in such a variable antenna having variable equipment is to match impedances with tuning stubs, which are simply strategically placed lengths of transmission line. Such tuning stubs are shunt elements, meaning they provide a parallel path with the main transmission line (series elements such as lumped resistors and capacitors do not work at microwave frequencies). Tuning stubs provide either capacitance, if open-circuited, or inductance, if short-circuited, to cancel a mismatch. Due to ease of implementation, the shunt capacitance tuning stub is the most commonly used.

When tuning an antenna that has a fixed, non-variable radiation pattern, it is relatively easy to identify locations to place tuning stubs. Since fixed parameter antennas generate only one set of phase and magnitude weightings for the array elements, antennas generally behave the same from antenna to antenna, except for variations caused by the manufacturing process. Referring now to FIG. 1, there is shown a schematic layout of a known antenna system. As may be seen in FIG. 1, there is an antenna 26 with a feed network 20 including an input 22, with input 22 electrically connected to antenna 26 via a transmission line 24, and antenna 26 tuned with tuning stubs 28. A typical feed network 20 is shown in FIG. 1. Network 20 includes an input 22 that branches off via transmission lines 24 to a plurality of antenna elements 26. A pair of shunt capacitive tuning stubs 28 is attached to each respective transmission line 24 which leads to two antenna elements 26.

However, in a variable antenna, such as a VED antenna wherein a downtilt is achieved by exciting the feed network with different sets of phase and/or magnitude weightings, the antenna system elements must be changed either physically or electrically to account for impedance mismatch variations that occur due to different configurations of the variable antenna. This physical or electrical changing is cumbersome.

As such, in accordance with FIG. 1, one could tune a variable antenna in one configuration, such as a VED antenna at a single downtilt, with relative ease, but the reflected electric field in the network will be unique at each configuration, and thus will excite a unique set of standing waves in the network for each configuration that must be accounted for by tuning in each configuration. Further, the optimum tuning locations for one variable antenna, such as a downtilt antenna, in its configuration set are very unlikely to be optimum for other variable antennas in their respective configuration sets. These factors make the use of traditional tunings stubs, as shown in FIG. 1, much more difficult in a variable antenna embodiment.

Due to these factors, known methods for tuning variable antennas do not provide high levels of radiated power and antenna performance at settings other than the variation of the antenna for which the tuning was done, because conventional tuning methods involve adding tuning stubs at a fixed point on the feed network. Such tuning remains fixed, even though the signal to be tuned in the feed network changes with variations in the variable settings of the antenna. Impedance mismatch results, changing the voltage standing wave ratio and adversely affecting the antenna performance.

Thus, known techniques are limited. These techniques fail to compensate for active variations in reflections that can occur in a variable antenna.

Accordingly, a need exists for an improved antenna, and a system and method of modifying the tuning of a variable antenna in response to a change in the variable configuration of the antenna. Further, there is a need for an antenna, system and method for keeping a variable antenna tuned throughout the variations of the variable configurations in the variable antenna.

While the present invention is described herein below, for illustrative purposes, as being applied to certain specific variable antennas, such as variable electrical downtilt antennae, it will be understood that the present invention can be employed in any antenna system that can be tuned by adjusting a capacitive or inductive element that is connected in parallel with the signal transmission line, in order to compensate for impedance mismatches.

### SUMMARY OF THE INVENTION

The present invention includes a tuneable antenna system including a transmission line coupled to an antenna, the transmission line having a movable portion, wherein a first position of the movable portion provides to the transmission line a first path length different from a second path length at a second position of the movable portion. A coupling of a first tuner to the movable portion at the first position presents to the transmission line a first impedance, and a coupling of a second tuner to the movable portion at the second position presents to the transmission line a second impedance different from the first impedance.

In an antenna system including an antenna assembly, a signal transmission line, a phase adjusting element, a sensor for measuring the electrical characteristics of the antenna system, a controller capable of adjusting the impedance level coupled to the system by causing the system to change from being coupled to a first impedance element to being coupled to a second impedance element, and a processor for receiving signals from the sensor and for outputting signals to the controller to cause the controller to change the impedance level coupled to the system, a method of controlling an antenna system includes the steps of coupling the signal transmission line to the antenna assembly; adjusting the electrical downtilt of the antenna assembly between at least a first downturn angle and a second downturn angle; measuring the electrical characteristics of the antenna assembly; and adjusting the impedance level coupled to the system based upon the measured electrical characteristics of the antenna assembly.

A system for varying the path length of a tunable antenna includes a transmission line coupled to the antenna, the transmission line having at least one movable portion for selecting one of a first and second position, the first position creating a first path length of the transmission line and the second position creating a second path length of the transmission line.

A system for varying the impedance of a tunable antenna includes a transmission line coupled to the antenna, the transmission line having at least one movable portion for selecting one of a first and second position and at least a first and a second tuner, the first tuner coupled to the movable portion of the transmission line when the movable portion is in the first position to thereby provide the transmission line with a first impedance, and the second tuner coupled to the movable portion of the transmission line when the movable portion is in the second position to thereby provide the transmission line with a second impedance, wherein the first impedance and the second impedance permit a varied impedance of the tunable antenna.

A method of tuning an antenna includes coupling a transmission line to the antenna, the transmission line having a movable portion; actuating the movable portion between a first position in which the signal transmission line has a first path length and a second position in which the signal transmission line has a second path length; and providing at least first and second tuner, the first tuning element being coupled to the movable portion of the signal transmission line when the movable portion is in the first position to thereby provide the signal transmission line with a first impedance, the second tuning element being coupled to the movable portion of the signal transmission line when the movable portion is in the second position to thereby provide the signal transmission line with a second impedance.

As such, the present invention provides an improved antenna for, and a system and method of, modifying the tuning of a VED antenna in response to a change in the downtilt of the antenna.

### BRIEF DESCRIPTION OF THE FIGURES

Understanding of the present invention will be facilitated by consideration of the following detailed description of the present invention taken in conjunction with the accompanying drawings, in which like numerals refer to like parts, and wherein:

FIG. 1 is a schematic layout of a known antenna system;

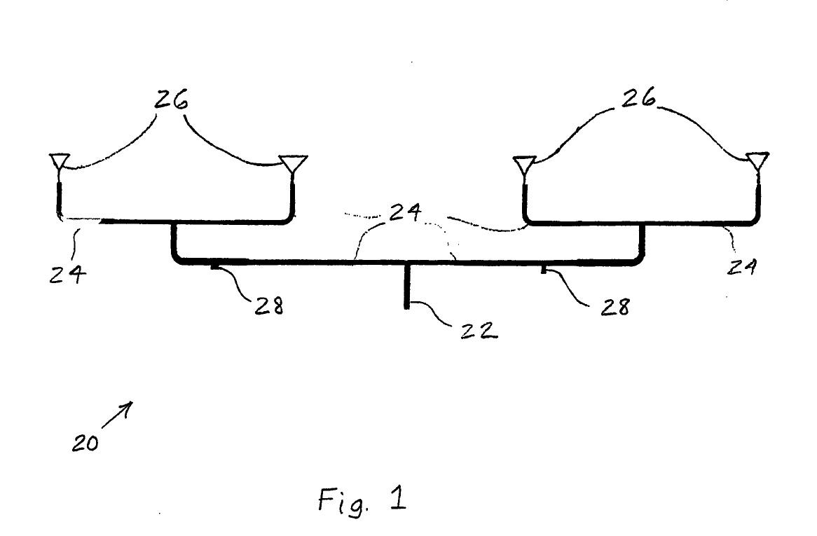

FIG. 2 is a schematic view of an embodiment of the phase shifting and tuning mechanism in a first position and a second position;

FIG. 3 is a schematic diagram of the phase shifting and tuning mechanism according to an aspect of the present invention in a first position and a second position;

FIG. 4 is a schematic view of a phase shifting and tuning mechanism according to an aspect of the present invention;

FIG. 5 is a schematic view of a phase shifting and tuning mechanism according to an aspect of the present invention;

FIG. 6 is a schematic of a side view of the phase shifting and tuning mechanism of FIG. 5 along line 14-14;

FIG. 7 is a schematic of a side view of the phase shifting and tuning mechanism according to an aspect of the present invention;

FIG. 8 is a schematic side view of the phase shifting and tuning mechanism according to an aspect of the present invention;

FIG. 9 is a block diagram of a method for operating the antenna system according to an aspect of the present invention;

FIG. 10 is a block diagram of a method for operating the antenna system according to an aspect of the present invention; and,

FIG. 11 is a block diagram of a method for operating the antenna system according to an aspect of the present invention.

Although the drawings represent embodiments of the present invention, the drawings are not necessarily to scale and certain features may be exaggerated in order to better illustrate and explain the present invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical antenna applications, and systems and methods of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

As discussed hereinabove, variable antennas often have one or more moving parts that allow for changes in antenna parameters to be made such that antenna performance may be modified. For example, the directionality, beam steering, size or strength, or the phase of an antenna may be modified in accordance with a configuration change of such a variable antenna. Such a configuration change may be made manually or automatically, and locally or remotely, such as through the use of extension or retraction of an arm-element of the antenna respondent to an activation of an actuator associated with the arm-element.

The present invention overcomes the detrimental effects on antenna characteristics that occur in the prior art upon variation of the configuration of a variable antenna, and further overcomes these detrimental effects in multiple configurations of such a variable antenna. Rather than employing fixed tuning stubs for one particular configuration of a variable antenna, as has been done in the prior art, the present invention provides a variable tuning that varies with changes in the configuration of a variable antenna. This variable tuning may be provided, in part, by a partial association of the tuning function with the one or more moving parts used to change the configuration of a variable antenna. For example, portions of the tuning element may be placed on a part of the antenna system that moves during a change in configuration, such as by placement of a part of a tuning stub on such a moving part. Thereby, a change in the position of the moving part during a change in the configuration of the antenna provides a correspondent change in the tuning element present in the antenna system. As such, the present invention provides a variable tuning that is directly related the configuration variation in a variable antenna.

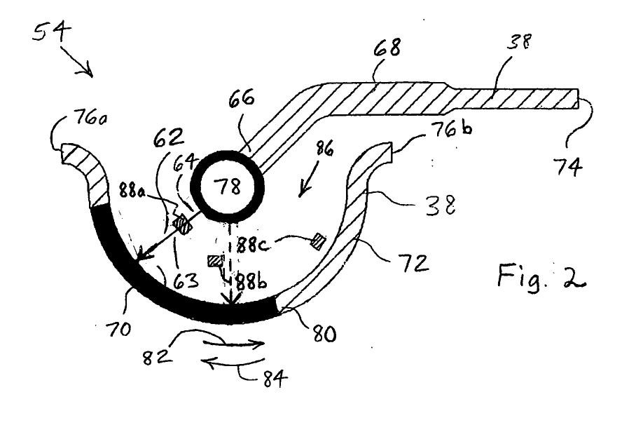

Referring now to FIG. 2, there is shown a schematic view of a phase shifting and tuning mechanism, according to an aspect of the present invention, at a first position (depicted with a solid line) and at a second position (depicted with a dotted line). Mechanism 54 may include a wiper 62, which is a movable portion of transmission line 38. Wiper 62 may include a first end 64 pivotably connected to an end 66 of a first section 68 of transmission line 38. A second end 70 of wiper 62 may be coupled to a second section 72 of transmission line 38. First section 68 may include an input end 74 for receiving a signal, such as from signal generator 60, for example. A received signal may be transmitted from input end 74 through first section 68, through wiper 62, and out one or both of two output ends 76a, 76b of second section 72. Each of output ends 76a, 76b may be coupled to a power splitter and feed network module 44.

An actuator 78, such as a stepper motor or a manually driven knob, may pivot wiper 62 such that second end 70 of wiper 62 sweeps along an arcuate subsection 80 of second section 72 in the directions indicated by arrows 82 and 84. For example, actuator 78 may rotate wiper 62 in direction 82 from the first position shown in FIG. 2 to the second position shown in FIG. 2. As may be seen in FIG. 2, the path length of transmission line 38 through output 76b is shortened by the rotation of wiper 62 in direction 82, thereby effecting a phase shift in the signal transmitted through output 76b and resulting in a corresponding variation in the antenna(s) coupled to output 76b. Conversely, the path length of transmission line 38 through output 76a may be lengthened by the rotation of wiper 62 in direction 82, thereby also effecting a phase shift in the signal transmitted through output 76a and resulting in a corresponding variation in the antenna(s) coupled to output 76a.

Each change, or variation, of the antenna may require a different tuning of the antenna system. According to an aspect of the present invention, the actuation described hereinabove, such as by causing a downtilt in a VED antenna, may be used to adjust the tuning of the antenna system. Mechanism 54 may include a tuning device 86 that provides transmission line 38 with a different level of impedance, i.e., a different tuning, for each position of wiper 62. Tuning device 86 may include a plurality of discrete tuners 88a, 88b, 88c that are arranged about the arc of movement of wiper 62. The configuration of tuner 88 may be arranged such that wiper 62 is coupled to at least one tuner 88 in each position of wiper 62. Wiper 62 may be moved relative to tuning device 86 and transmission line 38. Tuner 88a, 88b, 88c may be disposed in a pattern underneath wiper 62, as shown in FIG. 2. Tuner 88a, 88b, 88c may be sized less than a width of a shaft 63 of wiper 62 such that shaft 63 may substantially completely cover or eclipse one of tuner 88a, 88b, 88c. Tuner 88 may be spaced such that at least one tuner 88 couples to wiper 62.

In order to provide transmission line 38 with different impedances, tuners 88a, 88b, 88c may each have different physical and/or electrical characteristics, such that a different level of capacitance or inductance is achieved between wiper 62 and each individual one of tuner 88a, 88b, 88c when wiper 62 is disposed above or near that particular tuning element. Alternatively, tuner 88a, 88b, 88c may be identical physically and electrically, and may provide transmission line 38 with different impedances by virtue of the different positions of each along the path length of transmission line 38. Tuner 88 may be capable of providing impedance in parallel with the impedance of transmission line 38 to thereby change the overall impedance at the system level. Additional tuners 88 may be used. As depicted in FIG. 2, three tuners 88 may be utilized, but also any number of tuners 88 may be used, as may be realized by those possessing an ordinary skill in the pertinent arts.

Tuner 88a, 88b, 88c may not be electrically or physically connected to transmission line 38. Tuner 88a, 88b, 88c may be capacitively or inductively coupled to wiper 62 when wiper 62 is disposed above or near an associated tuning element. Tuner may alternatively be electrically or physically coupled to transmission line 38. While different coupling mechanisms may be utilized, tuner 88a, 88b, 88c may have no effect on the antenna system until wiper 62 is rotated above or near that particular tuning element. When wiper 62 is disposed above or near a particular tuning element, the tuning element may have an effect upon wiper 62, such as if a tuning stub was substituted for tuner 88a, 88b, 88c. According to an aspect of the present invention, as wiper 62 is rotated, transmission line 38 may be tuned for each level of impedance needed for each variation in antenna, such as for each different angle of downtilt. Tuning device 86 may include only tuner 88a, 88b, 88c, or may also include traditional tuning stubs. Tuner 88a, 88b, 88c may also be coupled to a ground plane.

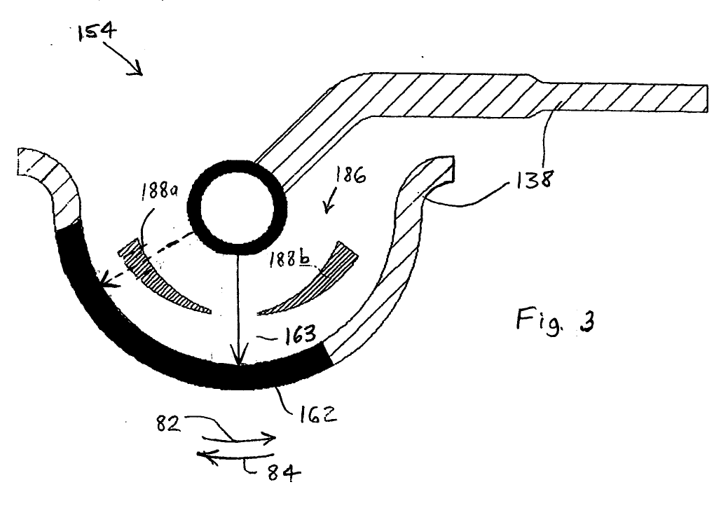

Referring now to FIG. 3, there is shown a schematic diagram of a phase shifting and tuning mechanism, according to an aspect of the present invention, at a first position (depicted as a solid line) and at a second position (depicted as a dotted line). As may be seen in FIG. 3, transmission line 138 and wiper 162 may be substantially identical to transmission line 38 and wiper 62, respectively, and thus will not be described in detail herein. Tuning device 186 may include arcuate, tapered tuners 188a, 188b, which may be shaped as mirror images of one another. The lengths of each of elements 188a, 188b along their respective arcs may be greater than the width of a shaft 163 of wiper 162, such that shaft 163 cannot completely cover or eclipse either of elements 188a, 188b.

The physical and electrical characteristics of elements 188a, 188b may be homogeneous over their surfaces such the amount of capacitance between wiper 163 and elements 188a, 188b may correspond, such as being proportional, to the amount of surface area of elements 188a, 188b that may be covered or eclipsed by shaft 163. For example, wiper 162 may cover a greater amount of surface area of element 188a in the second position of FIG. 3 than the total surface area of elements 188a, 188b that wiper 162 may cover in the first position of FIG. 3. Thus, the capacitance between wiper 162 and element 188a in the second position of FIG. 3 may be greater than the total capacitance between wiper 162 and elements 188a, 188b in the first position of FIG. 3.

Movement of wiper 162 in directions 82, 84 may provide a continuum of positions in which different levels of capacitance between wiper 162 and elements 188a, 188b may be achieved.

Tuning device 186 may provide wiper 162 with a different level of impedance at each of the continuum of positions of wiper 162.

As described above, an individual tuner 188a, 188b may provide transmission line 138 with different impedances depending upon where wiper shaft 163 is disposed along the arc of the tuning element. Thus, a single mass having multiple sections with respective impedance levels, such as either of elements 188a, 188b, may include multiple impedance elements. That is, as defined herein, multiple impedance elements may be included on a single mass, which may have homogeneous electrical and physical characteristics.

To provide transmission line 138 with different impedances, tuner 188a, 188b may each have different physical and/or electrical characteristics such that a different level of capacitance or inductance may be achieved between wiper 162 and each individual tuner 188a, 188b when wiper 162 is disposed above or near that particular tuning element. Alternatively, tuner 188a, 188b may be identical physically and electrically, and may provide transmission line 138 with different impedances by virtue of the different positions along the path length of transmission line 138.

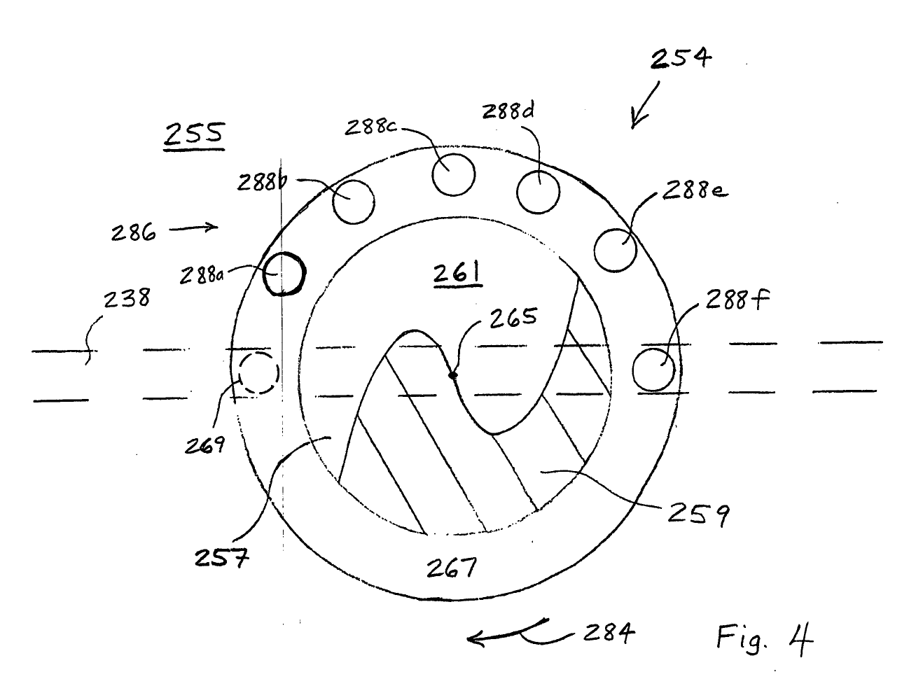

Referring now to FIG. 4, there is shown a schematic view of a phase shifting and tuning mechanism 254 according to an aspect of the present invention. The position of a signal transmission line 238 disposed above mechanism 254 is indicated in dashed lines. Mechanism 254 may be disposed between transmission line 238 and a ground plane 255. Mechanism 254 may include a dielectric element 257 that may affect the effective path length of transmission line 238 by slowing down or otherwise affecting the electric fields and thereby providing transmission line 238 with a longer effective length. Dielectric element 257 may include a dielectric section 259 formed of a dielectric material, and a non-dielectric section 261 formed of a non-dielectric material. The amount of lengthening of the effective path length may correspond to the surface area of dielectric section 259 that is covered or eclipsed by transmission line 238. Dielectric element 257 may be rotated about an axis 265 perpendicular to both transmission line 238 and element 257. Such a rotation may adjust the amount of surface area of dielectric section 259 covered by transmission line 238. The shapes and sizes of sections 259, 261 may be modified to suit any particular application.

Mechanism 254 may include a tuning device 286 having a plurality of tuners 288a, 288b, 288c, 288d, 288e, and 288f. Any number of tuners may be used, with six depicted in FIG. 4 for discussion purposes only. Tuning device 286 may be attached to dielectric element 257 such that device 286 and element 257 rotate together about axis 265. For example, tuner 288 may be supported by an annular or disc-shaped device 267 that is attached to dielectric element 257. In the position shown in FIG. 4, tuning element 288f may be coupled to transmission line 238 such that element 288f, to the exclusion of other elements 288a-e, affects the impedance of transmission line 238. If element 257 and device 267 were rotated in a clockwise direction 284, one of tuner 288a-e may be moved into a coupled relationship with transmission line 238 instead of element 288f. Each of elements 288a-f may have different physical and/or electrical characteristics such that each of elements 288a-f may provide transmission line 238 with different impedance. Rotation of disc-shaped device 267 may select a single element 288a-f or may be configured to select a combination of elements 288a-f. The rotation may change the amount of surface area of dielectric section 259 covered by transmission line 238. Thus, rotation of element 257 and device 267 may result in a change in the impedance of transmission line 238, such as for tuning of transmission line 238, and a change in the effective path length of transmission line 238, such as for producing a phase shift. Element 257 and device 267 may be rotated by an actuator such as a motor or a manually driven knob.

A second rotation, such as a camming, of device 267 may couple element 288a-f to transmission line 238 in the position indicated by dashed circle 269. Elements 288a-f may provide transmission line 238 with a second set of impedances at position 269 by virtue of being disposed at a different place along the length of transmission line 238.

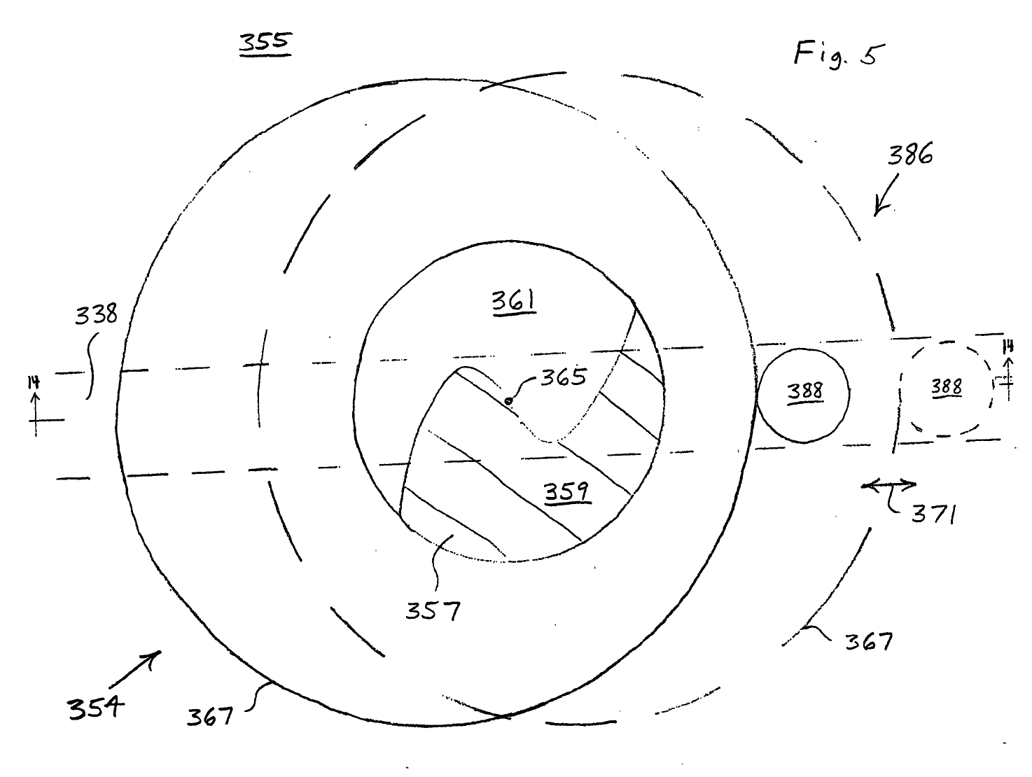

Referring now to FIG. 5, there is shown a schematic view of a phase shifting and tuning mechanism 354 according to an aspect of the present invention. The position of a signal transmission line 338 disposed above mechanism 354 may be indicated in dashed lines. Mechanism 354 may be disposed between transmission line 338 and a ground plane 355. Mechanism 354 may include a dielectric element 357 that may affect the effective path length of transmission line 338 by slowing down or otherwise affecting the electric fields and thereby providing transmission line 338 with a longer effective length. Dielectric element 357 may include a dielectric section 359 formed of a dielectric material, and a non-dielectric section 361 formed of a non-dielectric material. The amount of lengthening of the effective path length may correspond to the surface area of dielectric section 359 that is covered or eclipsed by transmission line 338. Dielectric element 357 may be rotated about an axis 365 perpendicular to both transmission line 338 and element 357, in order to adjust the amount of surface area of dielectric section 359. The shapes and sizes of sections 359, 361 may be modified to suit a particular application.

Mechanism 354 may include a tuning device 386 having a tuning element 388 movable in the direction indicated by double arrow 371 along the length of transmission line 338.

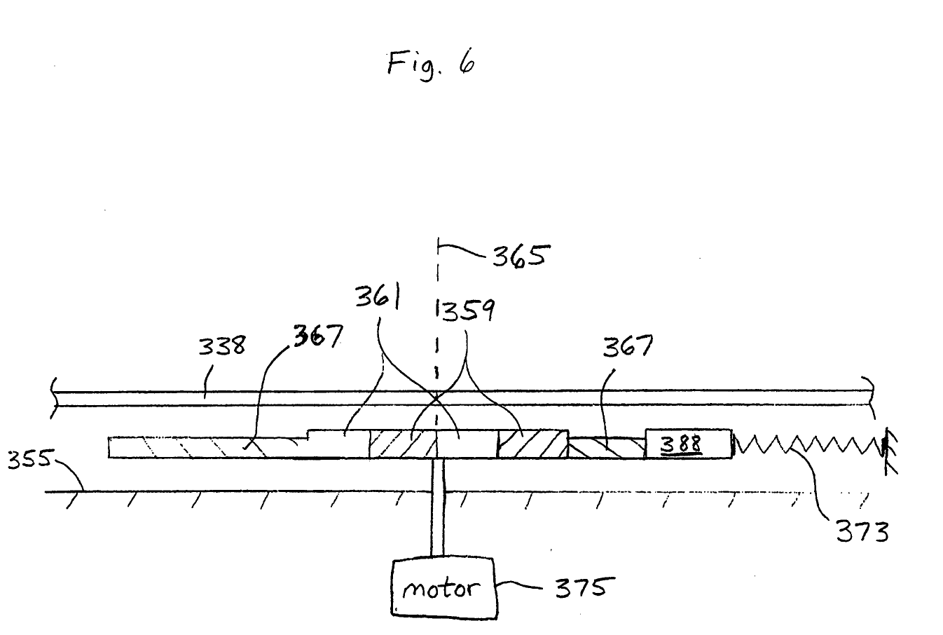

Referring now also to FIG. 6, there is shown a schematic of a side view of the phase shifting and tuning mechanism of FIG. 5 along line 14-14. Element 388 may be driven in directions 371 by the rotation of a cam 367 and the bias of a spring 373, as shown in FIG. 6. Cam 367 may be attached to dielectric element 357 such that cam 367 and element 357 rotate together about axis 365. The positions of cam 367 and element 388 after a 180° rotation of cam 367 may be seen as dashed circles in FIG. 6.

Tuning element 388 may provide transmission line 338 with different levels of impedance as element 388 moves in directions 371 by virtue of being at different positions along the length of transmission line 338. The movement of element 388 may result in the rotation of element 357 and cam 367. Another result of the rotation may be to change the amount of surface area of dielectric section 359 covered by transmission line 338. Thus, rotation of element 357 and cam 367 may result in both a change in the impedance of transmission line 338, causing a tuning of transmission line 338, and a change in the effective path length of transmission line 338, causing a phase shift. Element 357 and cam 367 may be rotated by an actuator such as a motor 375 or a manually driven knob.

It is to be understood that it is possible in both mechanisms 254 and 354 to eliminate the dielectric, and use the mechanism only for tuning and not for phase shifting.

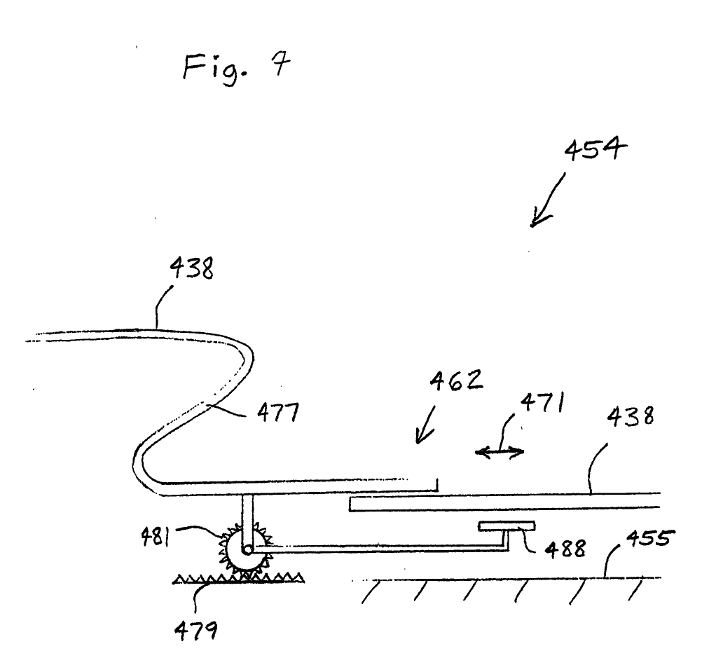

Referring now to FIG. 7, there is shown a schematic of a side view of the phase shifting and tuning mechanism 454 according to an aspect of the present invention. Mechanism 454 may include a trombone-type phase shifter 462 for adjusting a path length of transmission line 438. Transmission line 438 may include a flexible section 477 for accommodating movement of shifter 462 in the directions indicated by double arrow 471. Mechanism 454 may be disposed between transmission line 438 and a ground plane 455. Mechanism 454 may include a rack 479 and pinion 481 combination for moving both shifter 462 and a tuning element 488 in directions 471 along the length of transmission line 438.

Tuning element 488 may provide transmission line 438 with different levels of impedance as element 488 moves in directions 471 by virtue of being at different positions along the length of transmission line 438. The movement of element 488 may result in the rotation of pinion 481 along rack 479. A change in the path length of transmission line 438 may also result from the rotation. Thus, rotation of pinion 481 may result in both a change in the impedance of transmission line 438, such as for tuning of transmission line 438, and a change in the path length of transmission line 438, such as for imparting a phase shift. Pinion 481 may be rotated by an actuator such as a motor or a manually driven knob.

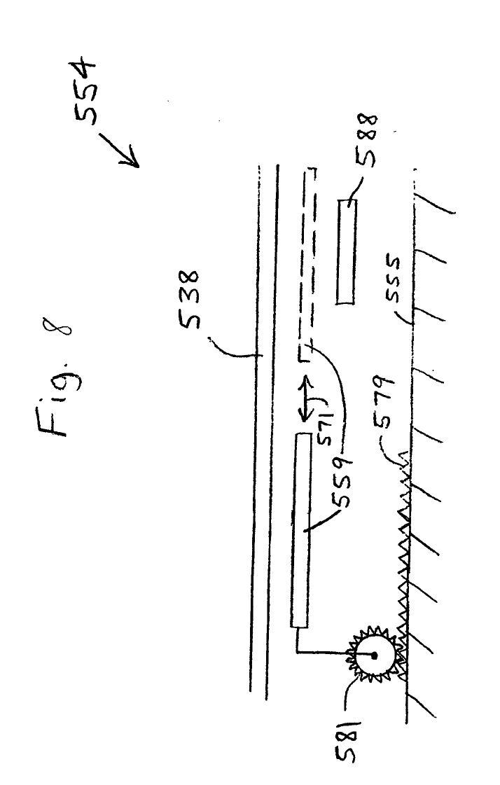

Referring now to FIG. 8, there is shown a schematic side view of the phase shifting and tuning mechanism 554 according to an aspect of the present invention. According to an aspect of the present invention, mechanism 554 may not have movement of transmission line 538 relative to a tuner 588 during operation of mechanism 554. As depicted in FIG. 8, a dielectric element 559 may be moved relative to transmission line 538 and tuner 588 in the directions indicated by double arrow 571. This movement may affect a phase shift and change the impedance of transmission line 538 in one motion. Mechanism 554 may be disposed between transmission line 538 and a ground plane 555. Mechanism 554 may include a rack 579 and pinion 581 combination for moving dielectric 559 in direction 571 along the length of transmission line 538.

Tuning element 588 may provide transmission line 538 with different levels of impedance depending upon whether or not dielectric 559 is disposed between transmission line 538 and element 588. Moreover, the position of dielectric 559 relative to transmission line 538 may affect the electric field associated with transmission line 538 and thereby affect the effective path length of transmission line 538. Thus, movement of dielectric 559 relative to transmission line 538 may affect a phase shift. The movement of dielectric 559 may result of the rotation of pinion 581 along rack 579. Thus, rotation of pinion 581 and movement of dielectric 559 in directions 571 may result in both a change in the impedance of transmission line 538, such as a tuning of transmission line 538, and a change in the effective path length of transmission line 538, such as a phase shift. Pinion 581 may be rotated by an actuator such as a motor or a manually driven knob.

Dielectric 559 may be moved along the length of transmission line 538. However, it is also possible to move dielectric 559 in directions substantially perpendicular to the length of transmission line 538. In this manner, dielectric 559 may affect a phase shift of greater magnitude due to the changing distance between dielectric 559 and transmission line 538 as dielectric 559 moves.

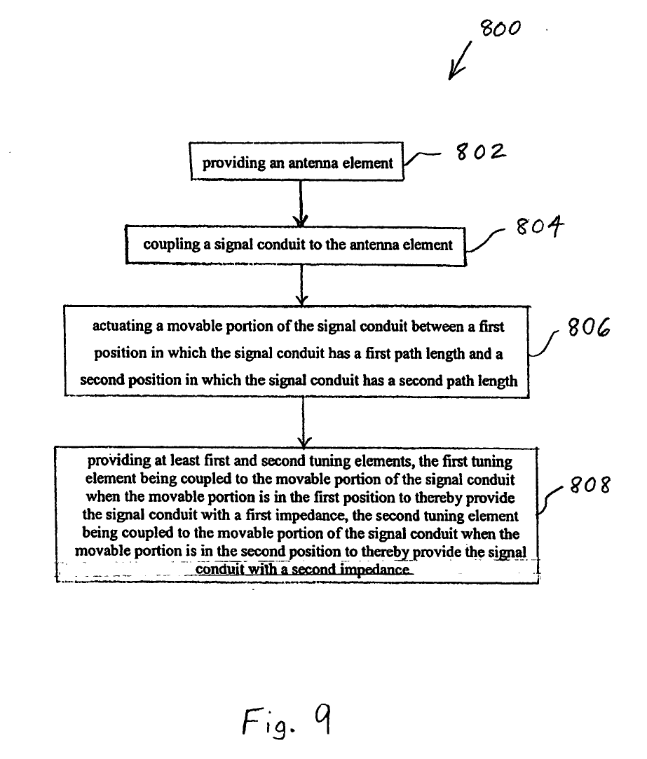

Referring now to FIG. 9, there is shown a block diagram of a method 800 for operating the antenna system according to an aspect of the present invention. Method 800 may include providing an antenna element 802, coupling a signal transmission line to the antenna element 804, actuating a movable portion of the signal transmission line between a first position in which the signal transmission line has a first path length and a second position in which the signal transmission line has a second path length 806, and providing at least first and second tuning elements, the first tuning element being coupled to the movable portion of the signal transmission line when the movable portion is in the first position to thereby provide the signal transmission line with a first impedance, the second tuning elements being coupled to the movable portion of the signal transmission line when the movable portion is in the second position to thereby provide the signal transmission line with a second impedance 808.

An antenna element may be provided, such as one of antenna elements 50. A signal transmission line 38 may be coupled to antenna element 50. A movable portion of signal transmission line 38, such as wiper 62, may be actuated between a first position, such as the first position of FIG. 2, in which the signal transmission line has a first path length, and a second position, such as the second position of FIG. 2, in which the signal transmission line has a second path length. At least a first and second tuner, such as tuners 88a, 88b, may be utilized. A first tuner may be coupled to the movable portion of the signal transmission line when the movable portion is in the first position to thereby provide the signal transmission line with first impedance. A second tuner may couple to the movable portion of the signal transmission line when the movable portion is in the second position to thereby provide the signal transmission line with second impedance.

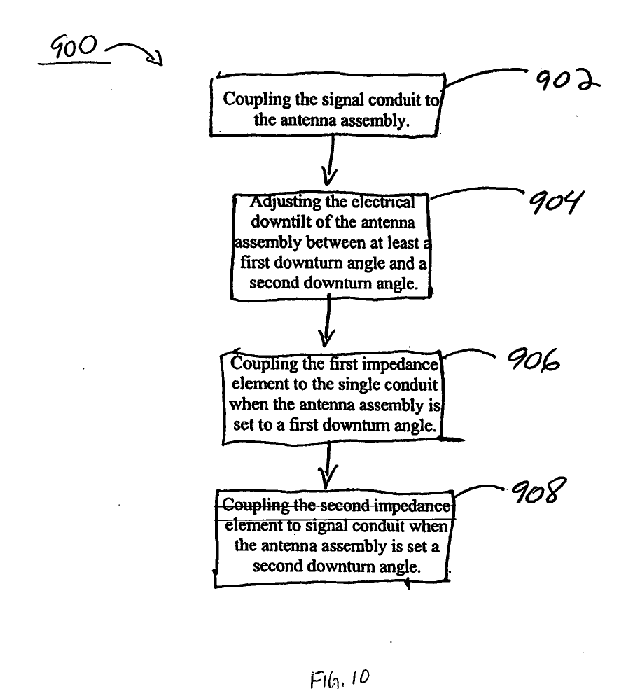

Referring now to FIG. 10, there is shown a block diagram of a method 900 for operating the antenna system according to an aspect of the present invention. As shown in FIG. 10, method 900 may include coupling the signal transmission line to the antenna assembly 902, adjusting the electrical downtilt of the antenna assembly between at least a first downturn angle and a second downturn angle 904, coupling the first impedance elements to the single transmission line when the antenna assembly is set to a first downturn angle 906, and coupling the second impedance element to signal transmission line when the antenna assembly is set a second downturn angle 908.

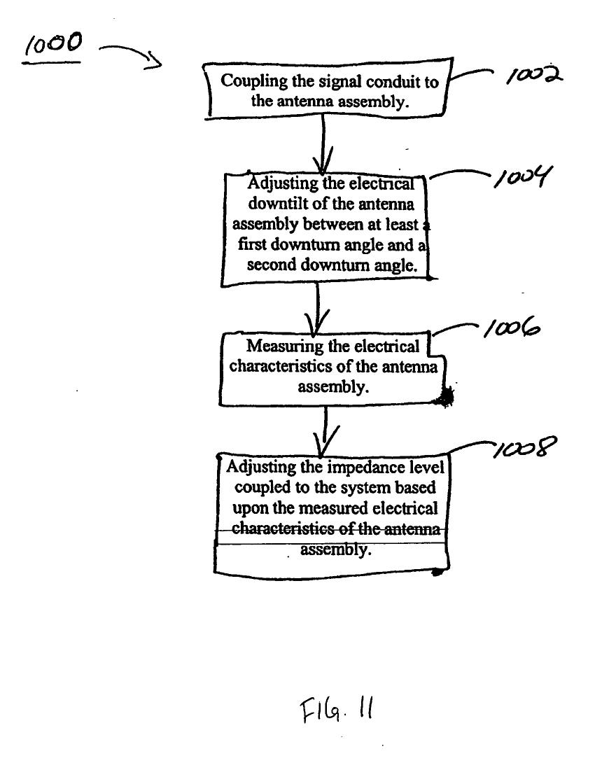

Referring now to FIG. 11, there is shown a block diagram of a method 1000 for operating the antenna system according to an aspect of the present invention. As shown in FIG. 11, the method may include coupling the signal transmission line to the antenna assembly 1002, adjusting the electrical downtilt of the antenna assembly between at least a first downturn angle and a second downturn angle 1004, measuring the electrical characteristics of the antenna assembly 1006, and adjusting the impedance level coupled to the system based upon the measured electrical characteristics of the antenna assembly 1008. In measuring the electrical characteristics 1006, electrical characteristics may include, by way of non-limiting example only: impedance, gain, signal strength, the presence or absence of standing waves, lobe strength and direction, the presence or absence of side lobes and other characteristics as well.

Although a VED antenna is used generally in the specific examples herein, the present invention may be applied to any antenna that has moving parts. Also, there may be any number of tuners, and the tuners may be of any number of sizes and shapes. In addition, instead of the tuner being stationary, the transmission line could be stationary, and the tuner could be moved along the transmission line to achieve the same result, such as changing the impedance of the transmission line and thus adjusting the tuning of the antenna system. For example, the tuning device may be moved closer to or farther away from the signal transmission line, in a direction perpendicular to a plane defined by the signal transmission line, rather than along the length of the signal transmission line as described herein.

The embodiments disclosed above are not intended to be exhaustive or to limit the invention to the precise forms disclosed in the detailed description. Rather, the embodiments have been chosen and described so that others skilled in the art may utilize their teachings. Although described in the exemplary embodiments, it will be understood that various modifications may be made to the subject matter without departing from the intended and proper scope of the invention.

1. A tuneable antenna system, comprising:
a transmission line coupled to an antenna, said transmission line having a movable portion, wherein a first position of the movable portion provides to said transmission line a first path length different from a second path length at a second position of the movable portion; and
at least first and second tuner, wherein a coupling of said first tuner to the movable portion at the first position presents to the transmission line a first impedance, and wherein a coupling of said second tuner to the movable portion at the second position presents to the transmission line a second impedance different from the first impedance.

2. The system of claim 1, wherein said first and second tuner comprise at least two sections of a single mass having at least two different impedance levels.

3. The system of claim 2, wherein said first and second tuner comprise at least two separate masses having two different impedance levels.

4. The system of claim 1, wherein changing from the first path length to the second path length affects a phase shift on a signal on said transmission line.

5. The system of claim 1, wherein at least one of said first and second tuner comprises:
a dielectric coupled to said transmission line, and
an actuator configured to move the dielectric relative to said transmission line to effectuate the difference in the path length of said transmission line, wherein the difference in the path length affects a phase shift on a signal on said transmission line.

6. The system of claim 5, wherein said dielectric is substantially planar and said actuator is configured to rotate said dielectric about an axis substantially perpendicular to said dielectric.

7. The system of claim 6, wherein a single mechanical force drives at least the rotation of the dielectric and the coupling from said first tuner to said second tuner.

8. The system of claim 1, further comprising:
at least one sensor for measuring electrical characteristics;
a controller capable of adjusting coupled impedance by causing a change from coupling to said first tuner to coupling to said second tuner; and
at least one processor for receiving signals from said sensor and for outputting signals to said controller to cause said controller to change the coupled impedance.

9. The system of claim 1, wherein the movable portion has a continuum of positions, and wherein said transmission line has a different one of the path lengths in each of the continuum of positions, and wherein said tuners providing to said transmission line a different impedance in each of the continuum of positions.

10. In an antenna system comprising an antenna assembly, a signal transmission line, a phase adjusting element, a sensor for measuring the electrical characteristics of the antenna system, a controller capable of adjusting the impedance level coupled to the system by causing the system to change from being coupled to a first impedance element to being coupled to a second impedance element; and a processor for receiving signals from the sensor and for outputting signals to the controller to cause the controller to change the impedance level coupled to the system, a method of controlling an antenna system, wherein the method comprises:
coupling the signal transmission line to the antenna assembly;
adjusting the electrical downtilt of the antenna assembly between at least a first downturn angle and a second downturn angle;
measuring the electrical characteristics of the antenna assembly; and
adjusting the impedance level coupled to the system based upon the measured electrical characteristics of the antenna assembly.

11. The system of claim 10, wherein the first and second impedance elements are two sections of a single mass having at least two different impedance levels.

12. The system of claim 10, wherein the first and second impedance elements are two separate masses having two different impedance levels.

13. A system for varying the path length for a tuneable antenna, said system comprising:
a transmission line coupled to the tuneable antenna, said transmission line having at least one movable portion for selecting one of a first and second position, said first position creating a first path length of said transmission line and said second position creating a second path length of said transmission line.

14. The system of claim 13, wherein said movable portion is actuated by the mecahnism for tuning the antenna.

15. A system for varying the impedance of a tunable antenna, said system comprising:
a transmission line coupled to the antenna, said transmission line having at least one movable portion for selecting one of a first and second position; and
at least a first and a second tuner, said first tuner coupled to the movable portion of said transmission line when the movable portion is in said first position to provide said transmission line with a first impedance, and said second tuner coupled to the movable portion of said transmission line when the movable portion is in said second position to provide said transmission line with a second impedance,
wherein said first impedance and said second impedance provide different correspondent impedances to the tunable antenna.

16. A method of tuning an antenna, said method comprising:
coupling a signal transmission line to the antenna, said transmission line having a movable portion;
actuating said movable portion between a first position in which the signal transmission line has a first path length and a second position in which the signal transmission line has a second path length; and
providing at least first and second tuners, the first tuner being coupled to the movable portion of the signal transmission line when the movable portion is in the first position to provide the signal transmission line with a first impedance, the second tuner being coupled to the movable portion of the signal transmission line when the movable portion is in the second position to provide the signal transmission line with a second impedance.

17. The method of claim 16, wherein the movable portion has a continuum of positions, and wherein the signal transmission line has a different path length in each of the continuum of positions, and wherein the tuners provide the signal transmission line with a different impedance in each of the continuum of positions.

18. The method of claim 16, further comprising:
sensing the electrical characteristics of the tuneable antenna; and,
adjusting the impedance coupled to the tuneable antenna by causing the system to change from being coupled to a first impedance element to being coupled to a second impedance element responsive to said sensing.

19. The method of claim 16, further comprising coupling said transmission line to the tuneable antenna.

20. The method of claim 16, further comprising adjusting electrical downtilt of the tuneable antenna between at least a first downturn angle and a second downturn angle.
